(19) United States
(12) Patent Application Publication
(10) Pub. No.: US 2021/0110012 A1
(43) Pub. Date: Apr. 15, 2021

(54) TARGETED PASSWORD LIST GENERATION

(71) Applicant: Brendan Hooke, Ashburn, VA (US)

(72) Inventor: Brendan Hooke, Ashburn, VA (US)

(21) Appl. No.: 17/070,615

(22) Filed: Oct. 14, 2020

Related U.S. Application Data
(60) Provisional application No. 62/914,885, filed on Oct. 14, 2019.

(51) Int. Cl. G06F 21/31

(52) U.S. Cl. CPC G06F 21/31

(57) ABSTRACT

Systems and techniques are provided for targeted password list generation. Characteristic data for an owner or user of an electronic device may be received at a computing device. Electronic source data for the owner or user of the electronic device may be received at the computing device. Group data for the owner or user of the electronic device may be received at a computing device. A targeted password list for the electronic device based on the characteristic data, the electronic source data, and the group data for the owner or user of the electronic device may be generated by the computing device.

### BACKGROUND

Access to password protected electronic devices for which the password is not known may be time-critical. Brute force generation of passwords to access a password protected device may take large amounts of time.

### BRIEF SUMMARY

In an implementation, characteristic data for an owner or user of an electronic device may be received at a computing device. Electronic source data for the owner or user of the electronic device may be received at the computing device. Group data for the owner or user of the electronic device may be received at a computing device. A targeted password list for the electronic device based on the characteristic data, the electronic source data, and the group data for the owner or user of the electronic device may be generated by the computing device.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for targeted password list generation according to an implementation of the disclosed subject matter.

FIG. 2 shows an example arrangement suitable for targeted password list generation according to an implementation of the disclosed subject matter.

FIG. 3 shows an example arrangement suitable for targeted password list generation according to an implementation of the disclosed subject matter.

FIG. 4 shows an example arrangement suitable for targeted password list generation according to an implementation of the disclosed subject matter.

FIG. 5 shows an example procedure suitable for targeted password list generation according to an implementation of the disclosed subject matter.

FIG. 6 shows an example procedure suitable for targeted password list generation according to an implementation of the disclosed subject matter.

FIG. 7 shows a computer according to an embodiment of the disclosed subject matter.

FIG. 8 shows a network configuration according to an embodiment of the disclosed subject matter.

### DETAILED DESCRIPTION

Targeted password generation may allow for the generation of a targeted password list based on several data sources that may include data related to the owner or user of an electronic device that the targeted password list is being generated for. The targeted password list may be used in conjunction with brute force techniques to gain access to a password protected electronic device. This may result in faster access to the electronic device than would be accomplished using brute force techniques without the targeted password list. Use of the targeted password list may reduce both the amount of time and the computation costs of accessing an electronic device that is password-protected. The targeted password list may be generated using data from different data sources, including data about known characteristics of the owner or user of an electronic device, data about the owner or primary user of the electronic device gathered from electronic sources, and data about demographic groups and organizations associated with the owner or user of the electronic device. Data from the different data sources may be combined to generate strings of characters that may be potential passwords for the targeted password list. The order in which strings from the targeted password list are used to attempt to gain access to an electronic device may be based on a hierarchy that may include priorities for data from the different data sources. Additional data may be obtained through field research conducted on demographic groups and organizations with which the owner or user of the electronic device may be associated.

To generate a targeted password list for a password protected electronic device, data may be gathered from different data sources. The electronic device may be, for example, a smartphone, tablet, laptop, personal computer, or any other suitable electronic device that may be protected by a password. The data may be collected by, for example, a software component of a computing device that may be able to, or may be connected to another computing device that may be able to, apply brute force techniques to a password protected electronic device to attempt to gain access to the password protected electronic device. The computing devices may be any suitable computing devices, using any suitable combination of hardware and software, and may include any combination of general purpose processors and special purpose processors, for example, processors intended to be used to apply brute force techniques to password protected electronic devices.

A software component of the computing device that collects data on the owner or user of an electronic device may prompt a user to enter data for known characteristics of the owner or user of the electronic device. The known characteristics may be, for example, name, date of birth, residence address, business address, social security number, phone number, identification assigned to the owner or user of the electronic device by, for example, a correctional facility or other governmental organization, known passwords for other electronic devices with the same owner or user, known passwords used by the owner or user for other purposes such as access to online accounts, and dates or numbers that may be known to be important to the owner or user, such as, for example, dates of birth of family members. Data for known characteristics entered by the user may be stored in any suitable format on the computing device. The data for known characteristics of the owner or user of an electronic device may be obtained by the user in any suitable manner, including through public records, investigation into the owner or user, documentation belonging to the owner or user, or from other individuals. The data may be input to the computing device directly through a human interface device of the computing, or may be input in any other suitable manner, such as, for example, through files or a database in a data storage physically connected to or otherwise accessible to the computing device, for example through a local or wide area network, including, for example, the Internet.

The software component of the computing device may prompt the user to enter data for known associations of the owner or user of the electronic device. The known associations may be between the owner or user of the electronic device and particular demographic groups or organizations, or other members of such demographic groups or organizations. The known associations may be used to gather data about the demographic groups or organizations. For example, the computing device may access a database that may include known demographic groups and organizations and data about those known demographic groups and organizations, such as, for example, numbers, phrases, and patterns that may be used by or meaningful to those demographic groups or organizations. Numbers used by or meaningful to a demographic group or organization may include, for example, country codes and area codes, street names and street numbers, and area names and area nicknames. The data about demographic groups or organizations may be stored in any suitable format on the computing device. Additional data may be obtained through field research conducted on demographic groups or organizations with which the owner and user of the electronic device is associated. This data may be collected through, for example, live interviews with people in or involved with the demographic groups or organizations, and may include, for example, numbers or phrases that interviewees indicate are used by or are important to the demographic groups or organizations. The data gathered through field research may be included in the database with data about demographic groups or organizations. The data about known associations of the owner or user of the electronic device may be input to the computing device directly through a human interface device of the computing, or may be input in any other suitable manner, such as, for example, through files or a database in a data storage physically connected to or otherwise accessible to the computing device, for example through a local or wide area network, including, for example, the Internet.

The software component of the computing device may prompt the user to upload or link to electronic sources that may include additional data about the owner or user of the electronic device. The electronic sources may be, for example, files, or links to files, in HTML, PDF, TXT, DOC, XLS, or any other suitable file format that may include text strings, including words and numbers. The electronic sources may be public, for example, HTML from webpages set up by the owner or user of the electronic device on a social media service, or may be non-public, such as, for example, reports generated through online investigation systems, reports accessed through proprietary online databases that may include, for example, news articles and court records, or password files generated by the use of brute force techniques on the electronic device or on another electronic device from the same owner or user. The electronic sources may include files retrieved from other electronic devices from the same owner or user of the electronic device, or from people or organizations associated with the owner or user of the electronic device. Data for the known characteristics of the owner or user of the electronic device may also be searched to obtain data from electronic sources. For example, the software component of the computing device may search the name of the owner or user of the electronic device on the Internet to locate webpages for social media accounts setup by the owner or user of the electronic device on a social media service. The data from electronic sources may be stored in any suitable format on the computing device after being uploaded to the computing device or obtained by the computing device through a provided link or through searching known characteristics of the owner or user of the electronic device.

Data from the different data sources may be combined to generate strings of characters that may be added to a targeted password list as potential passwords for the electronic device. The software component of the computing device may combine the data for known characteristics, data about demographic groups or organizations, and data from electronic sources in any suitable manner to generate strings of characters that may be used to attempt to access the password protected electronic device. The strings of characters may be based on the type of password used by the electronic device and any parameters for the password used by the electronic device. For example, if the electronic device uses a password that only includes numbers, the strings of characters generated from the data from the various data sources may only include numbers. The strings of characters may be of any suitable length, which may depend on the length of passwords used by the electronic device. For example, if the electronic device uses passwords that have a maximum length of six characters, the strings of characters may be generated up to a maximum length of six characters. The generation of strings of characters for the targeted password list may use any suitable combinations, shifts, and permutations of the data for known characteristics, data about demographic groups or organizations, and data from electronic sources. Data may be used in any suitable format for generation of the strings of characters for the targeted password list. For example, dates may be used in month-day-year format, day-month-year format, with named months or numbered months, and two-digit years or four-digit years, or any other suitable permutation.

The order in which strings from the targeted password list are generated by the software component of the computing device and/or used to attempt to gain access to an electronic device may be based on a hierarchy that may include priorities for data from the different data sources. For example, data for known characteristics of the owner or user of the electronic device and data from electronic sources about the owner or user of the electronic device may be prioritized over data about demographic groups or organizations when generating and/or using strings of characters from the targeted password list. This may result in, for example, strings of characters using only known characteristics of the owner or user of the electronic device and data from electronic sources about the owner or user of the electronic device being generated and/or used to attempt to access the electronic device first, followed by strings of characters that use data for known characteristics and data from electronic sources in conjunction with data about demographic groups or organizations, and then followed by strings of characters that use only data about demographic groups or organizations.

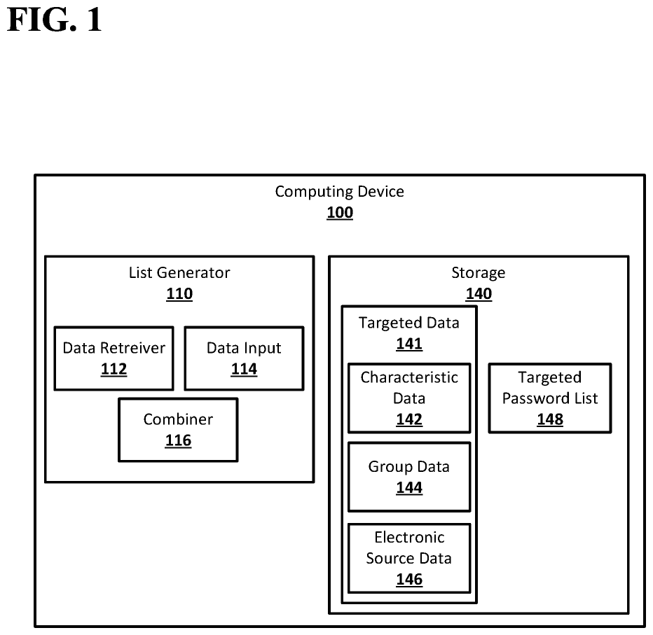

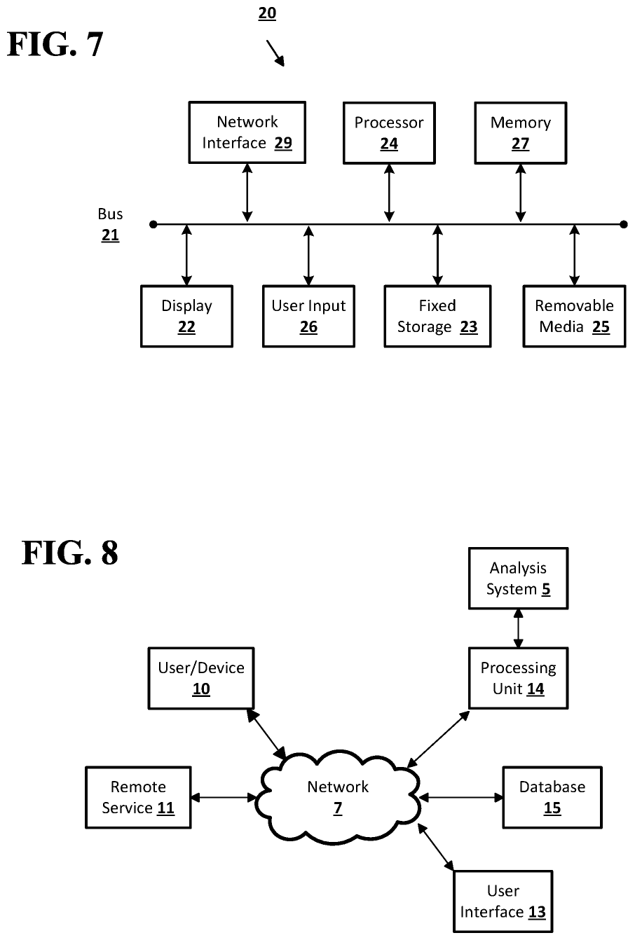

FIG. 1 shows an example arrangement suitable for targeted password list generation. A list generator 110 may run on a computing device 100. The computing device 100 may be any suitable computing device, such as, for example, a computer 20 as described in FIG. 7, or component thereof, for implementing the list generator 110 and the storage 140. The computing device 100 may be a single computing device, or may include multiple connected computing devices, and may be, for example, a laptop, a desktop, an individual server, a server farm, or a distributed server system, or may be a virtual computing device or system. The computing device 100 may be part of a computing system and network infrastructure or may be otherwise connected to the computing system and network infrastructure.

The list generator 110 may be any suitable combination of hardware and software on the computing device 100 for collecting data about the owner or user of an electronic device that is password protected and using the collected data to generate a targeted password list 148. The list generator 110 may, for example, be a software component of the computing device 100 that runs on the processing hardware of the computing device 100, which may include any suitable combination of general purpose and special purpose processors, including, for example, CPUs, GPUs, ASICs, and FPGAs. The list generator 110 may include a data retriever 112, which may scrape data from data sources external to the computing device 100 and from files uploaded to the computing device 100 and may retrieve data from databases, a data input 114, which may allow for the input of data to the list generator 110 from human interface devices connected to the computing device 100, and a combiner 116 which may generate strings of characters from data using combination, permutation, and shifting techniques. The data retriever 112, the data input 114, the combiner 116 may be, for example, software components, such as modules or features, of the list generator 110. In some implementations, any of the data retriever 112, the data input 114, the combiner 116 may be separate software components, for example, installable and executable independently of each other.

The storage 140 may be any suitable combination of volatile and non-volatile storage of the computing device 100 that may store characteristic data 142, which may include data for known characteristics of an owner or user of an electronic device, group data 144, which may include data about demographics groups or organizations associated with the owner or user of the electronic device, and electronic source data 146, which may be data from electronic sources about the owner or user of the electronic device. The characteristic data 142, group data 144, and electronic source data 146 may be targeted data 141. The targeted data 141 may be data about a specific individual who is the owner or user of a password protected electronic device that may be used to generate a targeted password list 148 to attempt to gain access to that password protected electronic device.

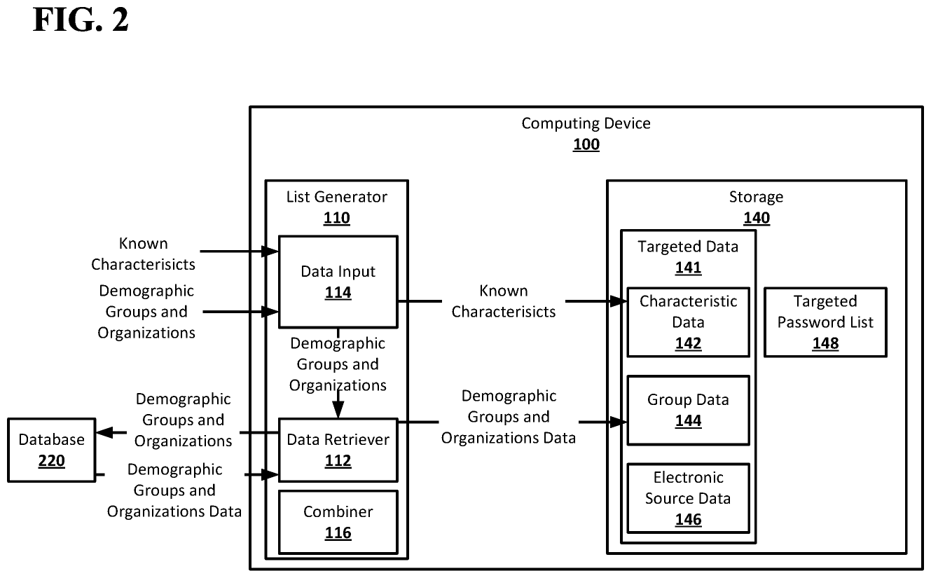

FIG. 2 shows an example arrangement suitable for targeted password list generation. A user of the computing device 100 may be prompted by the list generator 110 to enter known characteristics of an owner or user of an electronic device. The prompt may, for example, be displayed to a user on a display of the computing device 100. The known characteristics may be entered into the computing device 100, for example, through a human interface device such as a keyboard using a displayed graphical or command line interface for the list generator 110, and received at the list generator 110 by the data input 114. The known characteristics may be, for example, name, date of birth, residence address, business address, social security number, phone number, identification assigned to the owner or user of the electronic device by, for example, a correctional facility or other governmental organization, known passwords for other electronic devices with the same owner or user, known passwords used by the owner or user for other purposes such as access to online accounts, and dates or numbers that may be known to be important to the owner or user, such as, for example, dates of birth of family members. The known characteristics may be stored as the characteristic data 142 in the storage 140 as part of the targeted data 141, which may be in any suitable format. For example, the known characteristics may be stored as text in an ASCII file, or may be stored as strings in a spreadsheet or other suitable database file format.

A user of the computing device 100 may be prompted by the list generator 110 to enter known associations with demographic groups and organizations of the owner or user of an electronic device. The known associations with demographic groups and organizations of the owner or user of an electronic device, including identifiers for the demographic groups and organizations, may be entered in the computing device 100, for example, through a human interface device such as a keyboard using a displayed graphical or command line interface for the list generator 110, and received at the list generator 110 by the data input 114. Identifiers for the demographic groups and organizations may be received by the data retriever 112 from the data input 114. The data retriever 112 may access a database 220, which may include data for the demographic groups and organizations, including numbers and phrases that may be used by or meaningful to the demographic groups and organizations. The database 220 may be any suitable database that may be accessible to the computing device 100, and may be, for example, local to the computing device 100, or may be accessed through a wide area network such as the Internet, and may include data about various demographic groups and organizations. The data retriever 112 may access additional data sources than the database 220 to obtain data about demographic and organizations, including, for example, other databases and files external to the computing device 100 and databases and files already stored in the storage 140 of the computing device 100. The demographic groups and organizations data may be received by the data retriever 112 on the computing device 100, and stored as the group data 144 in the storage 140 as part of the targeted data 141, which may be in any suitable format. For example, the demographic groups and organizations data may be stored as text in an ASCII file, or may be stored as strings in a spreadsheet or other suitable database file format. The demographics groups and organizations data may be stored in a manner such that it can be distinguished from the known characteristics data. For example, the characteristic data 142 and group data 144 may be separate files or databases, or may be part of the same file or database that may include identifiers or other forms of computer-readable delineation between the characteristic data 142 and the group data 144.

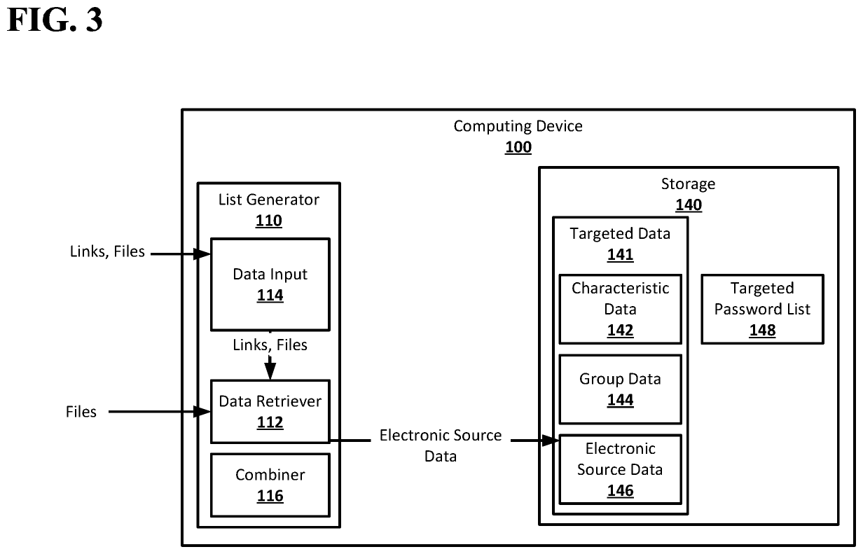

FIG. 3 shows an example arrangement suitable for targeted password list generation. A user of the computing device 100 may be prompted by the list generator 110 to input links and upload files with data about the owner or user of an electronic device. The links may be entered, and files uploaded, into the computing device 100, for example, through a human interface device, such as a keyboard, using a graphical or command line interface of the list generator 110, and received at the list generator 110 by the data input 114. The data retriever 112 may obtain additional files with data about the owner or user of the electronic device by using the links to access webpages and by searching for data from the characteristic data 142 on network accessible webpages and databases. The files with data bout the owner or user of the electronic device may be from public sources, such as, for example, webpages including webpages for social media accounts on social media services, or may be from non-public and proprietary sources, such as, for example, reports generated through online investigation systems, reports accessed through proprietary online databases that may include, for example, news articles and court records, password files generated by the use of brute force techniques on the electronic device or on another electronic device from the same owner or user, or files retrieved from other electronic devices from the same owner or user of the electronic device, or from people or organizations associated with the owner or user of the electronic device. Data for the known characteristics of the owner or user of the electronic device may also be searched to obtain data from electronic sources. The files with data about the owner or user of the electronic device received at the data retriever 112 may be in any suitable format, and may be converted by the data retriever 112 into a suitable format for storage as electronic source data 146 in the storage 140 as part of the targeted data 141. For example, text strings may be extracted from any files with data about the owner, which may be in, for example, HTML, PDF, TXT, DOC, XLS, or any other suitable format, and stored in the electronic source data 146. Data from files received at the data retriever 112 may be stored in a manner such that it can be distinguished from the known characteristics data and the demographics groups and organizations data. For example, the characteristic data 142, group data 144, and electronic source data 146 may be separate files or databases, or may be part of the same file or database that may include identifiers or other forms of computer-readable delineation between the characteristic data 142, the group data 144, and the electronic source data 146.

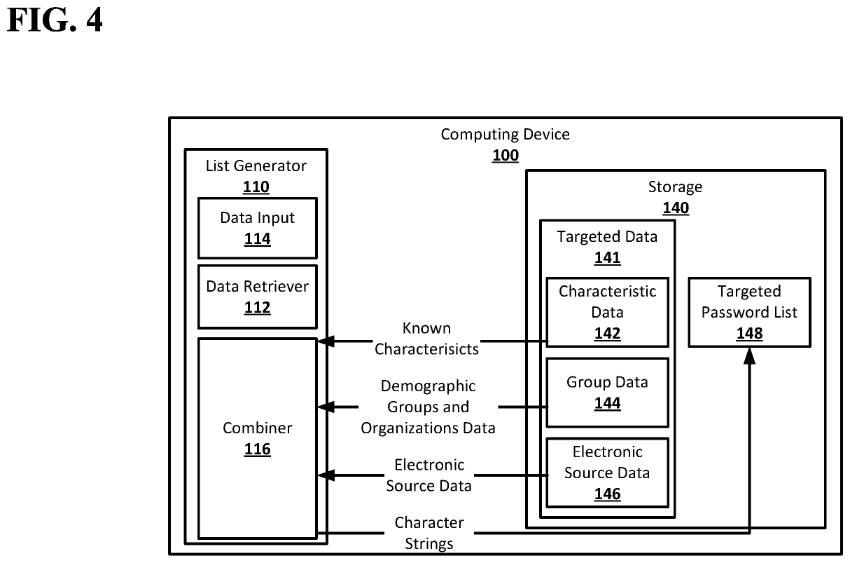

FIG. 4 shows an example arrangement suitable for targeted password list generation. The combiner 116 may retrieve the targeted data 141, including the known characteristics from the characteristic data 142, demographic groups and organization data from the group data 144, and electronic source data from the electronic source data 146. The combiner 116 may use the targeted data 141 to generate character strings of any suitable lengths, using any suitable character sets, based on the type of password used by the password protected electronic device whose owner or user the targeted data 141 was collected based on. The combiner 116 may use any suitable form of combination, permutation, and shifts of the targeted data 141 to generate the character strings. For example, combiner 116 may take strings of characters from the targeted data 141 and generate character strings for the targeted password list 148 by shifting and generating permutations of those strings of characters. The combiner 116 may also combine various strings of characters taken from the targeted data 141, store the resulting combined character strings in the targeted password list 148, and perform shifts and permutations on the combined character strings and store the resulting character strings in the targeted password list 148. The targeted password list 148 may include any number of character strings, with each character string being of any suitable length and including any suitable characters, for example, based on the parameters of the passwords used by the password protected electronic device.

The combiner 116 may generate character strings for the targeted password list 148 based on a hierarchy which may assign different priorities to the characteristic data 142, the group data 144, and the electronic source data 146. For example, the characteristic data 142 and electronic source data 146 may be prioritized over the group data 144. The combiner 116 may use the characteristic data 142 and the electronic source data 146 first when generating character strings and storing them in the targeted password list 148. The character strings stored in the targeted password list 148 generated using high priority data may be used first when attempting to access the password protected electronic device by inputting character strings from the targeted password list 148. For example, the character strings generated by the combiner 116 using the characteristic data 142 and the electronic source data 146 may be used to attempt to access the password protected electronic device that the targeted password list 148 was generated for before character strings generated using the group data 144 are used.

Character strings from the targeted password list 148 may be used to attempt access the password protected electronic device in any suitable manner. For example, the password protected electronic device may be connected to the computing device 100, which may include any suitable combination of hardware and software for inputting character strings from the targeted password list 148 as passwords to the password protected electronic device and for determining if a character string input as a password grants access to the password protected electronic device. The targeted password list 148 may also be used by another computing device, which may be a general or special purpose computing device, that may be connected to the password protected electronic device and may use the character strings on the targeted password list 148 to attempt to access the password protected electronic device.

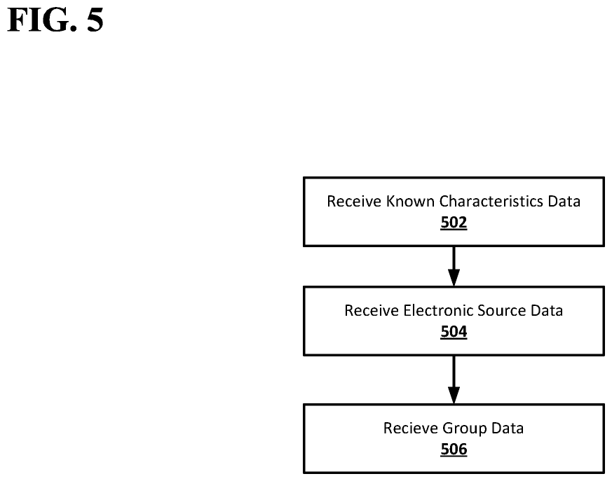

FIG. 5 shows an example procedure suitable for targeted password list generation. At 502, known characteristics data may be received. For example, known characteristic data for the owner or user of an electronic device that is password protected may be received at the computing device 100. The known characteristics data may be received, for example, through user input to the data input 114 of list generator 110, and stored as the characteristic data 142 as part of the targeted data 141.

At 502, electronic source data may be received. For example, electronic source data for the owner or user of an electronic device that is password protected may be received at the computing device 100. The electronic source data may include files input by a user to the data input 114 of the list generator 110, and files accessed by the data retriever 112 of the list generator 110 using links input by the user to the data input 114. The electronic source data may be stored as the electronic source data 146 in the targeted data 141.

At 506 demographic groups and organizations data may be received. For example, demographic groups and organizations data for the owner or user of an electronic device that is password protected may be received at the computing device 100. The demographic groups and organizations data may include data input by a user to the data input 114 of the list generator 110, and data accessed by the data retriever 112 of the list generator from databases such as the database 220. The demographic groups and organizations data may be stored as the group data 144 in the targeted data 141.

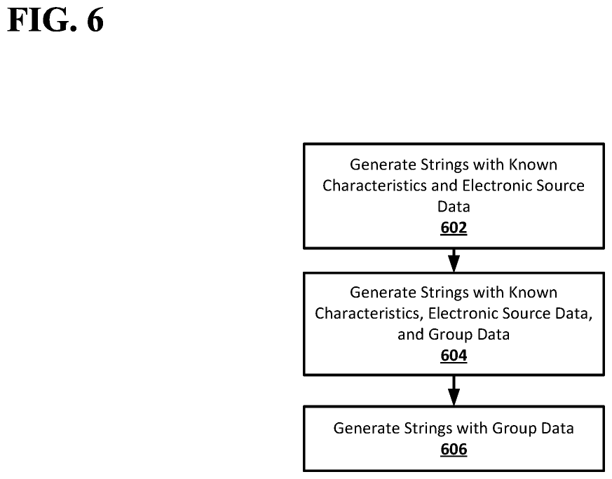

FIG. 6 shows an example procedure suitable for targeted password list generation. At 602, character strings may be generated using known characteristics data and electronic source data. For example, the combiner 116 may use the strings of characters in the characteristic data 142 for the owner or user of an electronic device and strings of characters from the electronic source data 146 to generate character strings for the targeted password list 148. The character strings may be generated using shifts and permutations of the strings of characters in the characteristic data 142 and combinations thereof, shifts and permutations of the strings of characters in the electronic source data 146 and combinations thereof, and shifts and permutations of combinations of the strings of characters in the electronic source data 146 and the strings of characters in the characteristic data 142.

At 604, character strings may be generated using known characteristics data, electronic source data, and data about demographics group and organizations. For example, the combiner 116 may use the strings of characters from all of the characteristic data 142 for the owner or user of an electronic device, the electronic source data 146, and the group data 144 to generate character strings for the targeted password list 148. The character strings may be generated using shifts and permutations of combinations of the strings of characters in the electronic source data 146, the strings of characters in the characteristic data 142, and strings of characters in the group data 144.

At 606, character strings may be generated using group data. For example, the combiner 116 may use the strings of characters from the group data 144 to generate character strings for the targeted password list 148. The character strings may be generated using shifts and permutations of the strings of characters in the group data 144.

Implementations of the presently disclosed subject matter may be implemented in and used with a variety of component and network architectures. FIG. 7 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection, or the like. For example, the network interface 29 may allow the computer to communicate with other computers via one or more local, wide-area, or other networks, as shown in FIG. 8.

Many other devices or components (not shown) may be connected in a similar manner (e.g., document scanners, digital cameras, and so on). Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, removable media 25, or on a remote storage location.

FIG. 8 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. The disclosed subject matter also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Implementations may use hardware that includes a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method performed by a data processing apparatus, the method comprising:
receiving, at a computing device, characteristic data for an owner or user of an electronic device;
receiving, at the computing device, electronic source data for the owner or user of the electronic device;
receiving, at the computing device, group data for the owner or user of the electronic device;
generating, by the computing device, a targeted password list for the electronic device based on the characteristic data, the electronic source data, and the group data for the owner or user of the electronic device.

2. The computer-implemented method of claim 1, wherein the characteristic data comprises strings of characters based on known characteristics of the owner or user of the electronic device.

3. The computer-implemented method of claim 1, wherein the electronic source data comprises strings of characters based on data about the owner or user of the electronic device retrieved from electronic data sources.

4. The computer-implemented method of claim 1, wherein the group data comprises strings of characters based on data about demographic groups and organizations with which the owner or user of the electronic device is associated.

5. The computer-implemented method of claim 1, wherein generating, by the computing device, the targeted password list for the electronic device based on the characteristic data, the electronic source data, and the group data for the owner or user of the electronic device comprises:
generating a first set of character strings by shifting and permutating strings of characters from the characteristic data;
generating a second set of character strings by shifting and permutating strings of characters from the electronic source data;
generating a third set of character strings by combining the strings of characters from the characteristic data and the strings of characters from the electronic source data;
generating a fourth set of character strings by combining the strings of characters from the characteristic data and the electronic source data and strings of characters from the group data;
generating a fifth set of character strings by shifting and permutating the strings of characters from the group data; and
storing the first, second, third, fourth, and fifth sets of character strings as the targeted password list for the electronic device.

6. The computer-implemented method of claim 5, wherein the first, second, and third sets of character strings are generated and stored before the fourth and fifth sets of character strings are generated and stored.

7. The computer-implemented method of claim 5, further comprising:
using character strings from the targeted password list to attempt to access the electronic device, wherein character strings from the first, second, and third sets of character strings are used before character strings from the fourth and fifth set of character strings are used.

8. The computer-implemented method of claim 1, wherein generating, by the computing device, the targeted password list for the electronic device based on the characteristic data, the electronic source data, and the group data for the owner or user of the electronic device is based on parameters of passwords used by the electronic device.

9. A computer-implemented system comprising:
one or more storage devices;
one or more processors that receive characteristic data for an owner or user of an electronic device, receive electronic source data for the owner or user of the electronic device, receive group data for the owner or user of the electronic device, and generate a targeted password list for the electronic device based on the characteristic data, the electronic source data, and the group data for the owner or user of the electronic device.

10. The computer-implemented system of claim 9, wherein the characteristic data comprises strings of characters based on known characteristics of the owner or user of the electronic device.

11. The computer-implemented system of claim 9, wherein the electronic source data comprises strings of characters based on data about the owner or user of the electronic device retrieved from electronic data sources.

12. The computer-implemented system of claim 9, wherein the group data comprises strings of characters based on data about demographic groups and organizations with which the owner or user of the electronic device is associated.

13. The computer-implemented system of claim 9, wherein the or more processors generate the targeted password list for the electronic device based on the characteristic data, the electronic source data, and the group data for the owner or user of the electronic device by generating a first set of character strings by shifting and permutating strings of characters from the characteristic data, generating a second set of character strings by shifting and permutating strings of characters from the electronic source data, generating a third set of character strings by combining the strings of characters from the characteristic data and the strings of characters from the electronic source data, generating a fourth set of character strings by combining the strings of characters from the characteristic data and the electronic source data and strings of characters from the group data, generating a fifth set of character strings by shifting and permutating the strings of characters from the group data, storing the first, second, third, fourth, and fifth sets of character strings in the one or more storage devices as the targeted password list for the electronic device.

14. The computer-implemented system of claim 13, wherein the first, second, and third sets of character strings are generated and stored before the fourth and fifth sets of character strings are generated and stored.

15. The computer-implemented system of claim 13, wherein the one or more processors further use character strings from the targeted password list to attempt to access the electronic device, wherein character strings from the first, second, and third sets of character strings are used before character strings from the fourth and fifth set of character strings are used.

16. The computer-implemented system of claim 9, wherein the one or more processors generate the targeted password list for the electronic device based on the characteristic data, the electronic source data, and the group data for the owner or user of the electronic device based on parameters of passwords used by the electronic device.

17. A system comprising: one or more computers and one or more storage devices storing instructions which are operable, when executed by the one or more computers, to cause the one or more computers to perform operations comprising:
generating a first set of character strings by shifting and permutating strings of characters from the characteristic data;
generating a second set of character strings by shifting and permutating strings of characters from the electronic source data;
generating a third set of character strings by combining the strings of characters from the characteristic data and the strings of characters from the electronic source data;
generating a fourth set of character strings by combining the strings of characters from the characteristic data and the electronic source data and strings of characters from the group data;
generating a fifth set of character strings by shifting and permutating the strings of characters from the group data; and
storing the first, second, third, fourth, and fifth sets of character strings as the targeted password list for the electronic device.

18. The system of claim 17, wherein the instructions, which are operable, when executed by the one or more computers, further cause the one or more computers to perform operations comprising:
generating a first set of character strings by shifting and permutating strings of characters from the characteristic data;
generating a second set of character strings by shifting and permutating strings of characters from the electronic source data;
generating a third set of character strings by combining the strings of characters from the characteristic data and the strings of characters from the electronic source data;
generating a fourth set of character strings by combining the strings of characters from the characteristic data and the electronic source data and strings of characters from the group data;
generating a fifth set of character strings by shifting and permutating the strings of characters from the group data; and
storing the first, second, third, fourth, and fifth sets of character strings as the targeted password list for the electronic device.

19. The system of claim 18, wherein the first, second, and third sets of character strings are generated and stored before the fourth and fifth sets of character strings are generated and stored.

20. The system of claim 18, wherein the instructions, which are operable, when executed by the one or more computers, further cause the one or more computers to perform operations comprising:
using character strings from the targeted password list to attempt to access the electronic device, wherein character strings from the first, second, and third sets of character strings are used before character strings from the fourth and fifth set of character strings are used.
